(19) United States
(12) Patent Application Publication
(10) Pub. No.: US 2019/0200199 A1
(43) Pub. Date: Jun. 27, 2019

(54) CHIP-ENHANCED BATTERY

(71) Applicant: Intel IP Corporation, Santa Clara, CA (US)

(72) Inventors: Michael Faerber, Wolfratshausen (DE); Ingolf Karls, Feldkirchen (DE); Yang Yang, Mannheim (DE); Miltiadis Filippou, Muenchen (DE); Camila Priale Olivares, Neubiberg (DE); Maria Fresia, Muenchen (DE); Leonardo Gomes Baltar, Muenchen (DE); Kilian Roth, Muenchen (DE)

(21) Appl. No.: 16/327,399

(22) PCT Filed: Sep. 5, 2016
(86) PCT No.: PCT/EP2016/070823

§ 371 Date: Feb. 22, 2019

(51) Int. Cl. H04W 4/70; H01M 10/42; H01M 2/02; H01M 2/34; H01M 6/50; H01M 10/44; H04W 4/24; H04M 15/00; H04L 12/14; H04W 12/00; H04W 12/06; H04L 29/06

(52) U.S. Cl. CPC H04W 4/70; H01M 2010/4278; H01M 2/0222; H01M 2/34; H01M 6/5066; H01M 10/4221; H01M 10/425; H01M 10/44; H04W 4/24; H04M 15/8214; H04L 12/1435; H04W 12/004; H04W 12/06; H04L 63/0876; H01M 10/4257

(57) ABSTRACT

The disclosure relates to a chip-enhanced battery for a machine type communication (MTC) device, the chip-enhanced battery comprising: a battery; and a microchip integrated with the battery, wherein the microchip comprises a subscriber identification module (SIM) with stored instructions to establish communication with a mobile network operator (MNO) upon an insertion of the chip-enhanced battery into the MTC device.

### FIELD

The disclosure relates to a chip-enhanced battery for a machine type communication device (MTC) and a method for using a chip-enhanced battery for communication with a mobile network operator (MNO). Such a smart battery includes a SIM (subscriber identification module) for establishing communication with a mobile network operator (MNO) when the battery is inserted in the MTC.

### BACKGROUND

In future 5G communication systems, voice-related services won't be the majority of mobile network operator (MNO) services. IoT (Internet of Things) UEs (User Equipments) are tailored for services intended to connect machines to a network with the aim of offering specific data-related services. They are designed to serve as sensors or machine type communication (MTC) units, requesting typically low data rates of a few hundreds of bytes, nonetheless, expecting dense deployment scenarios characterized by a massive presence of such devices over an area and space (one can imagine a multitude of potential applications, i.e., smart cities, defense, agriculture and others). The user and operator expectation is that these devices typically operate under low data rates, and the battery lifetime shall be up to 10 years. Application areas are metering and environment parameter reporting, with a wide range of simple radio interfaces. The challenge for the MNO is to keep control over a skyrocketing number of non-complex devices and to provide the technical means for managing the billing of these simple devices.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description.

FIG. 1 is a schematic diagram illustrating a communication system 100 with a chip-enhanced battery 110, an MTC device 120 and a MNO network 130 according to an implementation.

FIG. 2 is a schematic diagram illustrating a communications system with a chip-enhanced battery 210 connected with an MTC device 120 according to an implementation.

FIG. 3 is a schematic diagram illustrating a chip-enhanced battery 310 according to an implementation.

FIG. 4 is a block diagram illustrating a communication system 400 with elements which are involved in the validation process of a chip-enhanced battery according to an implementation.

FIG. 5 schematically illustrates an exemplary method 500 for using a chip-enhanced battery for communication with a mobile network operator (MNO) according to an implementation.

### DETAILED DESCRIPTION

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the present disclosure. The following detailed description, therefore, is not to be taken in a limiting sense, and the scope of the present disclosure is defined by the appended claims.

The following terms, abbreviations and notations are used herein:
IoT: Internet of Things
SIM: Subscriber Identity Module
eSIM: embedded Subscriber Identity Module
MNO: Mobile Network Operator (Network)
MTC: Machine Type Communication
UE: User Equipment,
ID: Identification (code)
QR code: Quick Response code
NFC: Near Field Communication
LED: Light Emitting Diode
3GPP: 3rd Generation Partnership Project,
LTE: Long Term Evolution,
RF: Radio Frequency,
DB: Data Base

The methods and devices described herein may be based on chip-enhanced batteries, i.e. smart batteries and methods for using chip-enhanced batteries for establishing communication with a MNO network. It is understood that comments made in connection with a described method may also hold true for a corresponding device configured to perform the method and vice versa. For example, if a specific method step is described, a corresponding device may include a unit to perform the described method step, even if such a unit is not explicitly described or illustrated in the figures. Further, it is understood that the features of the various exemplary aspects described herein may be combined with each other, unless specifically noted otherwise.

A battery according to the disclosure is an electric battery, i.e., a device including one or more electrochemical cells with external connections provided to power electrical devices. A discharging battery has a positive terminal, or cathode, and a negative terminal, or anode. The terminal marked negative is the source of electrons that when connected to an external circuit will flow and deliver energy to an external device. When a battery is connected to an external circuit, electrolytes are able to move as ions within, allowing the chemical reactions to be completed at the separate terminals and so deliver energy to the external circuit. It is the movement of those ions within the battery which allows current to flow out of the battery to perform work.

The methods and devices described herein may be applied in machine type communication (MTC) devices or machine-to-machine communication (M2M) devices. MTC or M2M communications refer to automated data communications among devices and the underlying data transport infrastructure. The data communications may occur between an MTC device and a server, or directly between two MTC devices. The communications among MTC devices can be handled through different network technologies. Point-to-point and multi-hop wireless networks, such as ad hoc networks, sensor and mesh networks, have been considered as a means to provide Internet access for devices, forming the so-called Internet of Things (IoT). In personal area networks, for instance, IEEE 802.15.x has been developed to serve a variety of applications. IEEE 802.11ah is another technology that supports low-power transmissions with extended coverage range in Wi-Fi networks.

The methods and devices described herein may be applied in environments according to the Internet of Things (IoT). They can be implemented with cellular wireless technologies like Sigfox, LoRa and NB-IoT, etc. providing coverage, latency and reliability in extreme dense environments for guaranteeing secure, identifiable and authenticated access to the mobile networks. The subscriber identity module (SIM) is the primary piece of operator supplied user equipment (UE) to access cellular wireless networks, which evolved most recently into embedded SIM (eSIM), fixed in the device and non-removable as well as SIM remote provisioning where a SIM can be updated over the air and is able to store one or more operator profiles. Methods, systems and devices according to the disclosure provide a new affordable scalable system for IoT UEs connected to wireless cellular networks which are combining batteries and eSIM providing a scalable, flexible and most efficient procurement, provisioning, maintenance and billing for millions and billions of IoT UE, as described hereinafter.

The methods and devices described herein may be implemented in wireless communication networks, in particular communication networks based on mobile communication standards such as LTE and in particular 5G. The methods and devices described below may be implemented in UEs and MTC devices. The described devices may include integrated circuits and/or passives and may be manufactured according to various technologies. For example, the circuits may be designed as logic integrated circuits, analog integrated circuits, mixed signal integrated circuits, optical circuits, memory circuits and/or integrated passives.

The methods and devices described herein may be configured to transmit and/or receive radio signals. Radio signals may be or may include radio frequency signals radiated by a radio transmitting device (or radio transmitter or sender) with a radio frequency lying in a range of about 3 Hz to 300 GHz. The frequency range may correspond to frequencies of alternating current electrical signals used to produce and detect radio waves.

The methods and devices described herein after may be designed in accordance to mobile communication standards such as e.g. the ones of the 3rd Generation Partnership Project (3GPP). Long Term Evolution (LTE), LIE-Advanced, LTE-Advanced Pro and the next generation standard are mentioned as representatives for wireless communication of high-speed data for mobile phones, data terminals and MTC devices.

The methods and devices described herein may be configured to transmit and/or receive light signals, in particular by using light emitting diodes (LEDs) and photo detectors. A light-emitting diode (LED) is a two-lead semiconductor light source. It is a p-n junction diode, which emits light when activated. When a suitable voltage is applied to the leads, electrons are able to recombine with electron holes within the device, releasing energy in the form of photons. This effect is called electroluminescence, and the color of the light (corresponding to the energy of the photon) is determined by the energy band gap of the semiconductor. Photo sensors or photo detectors are sensors of light or other electromagnetic energy. A photo detector converts light signals that hit the junction into voltage or current. The connection uses an illumination window with an anti-reflect coating to absorb the light photons. This results in creation of electron-hole pairs in the depletion region. Photodiodes and photo transistors are examples of photo detectors, other examples are solar cells as they absorb light and turn it into energy.

The methods and devices described herein may be configured to transmit and/or receive radio signals via near field communication (NFC). NFC is a standards-based technology which is used to provide short range wireless connectivity technology carrying secure two-way interactions between electronic devices. Communications are established in a simple way, not requiring set-up by users as in the case of many other wireless communications. NFC near field communication provides contactless communication up to distances of about 4 or 5 centimeters. In this way communication is inherently more secure because devices normally only come into contact and hence communication when the user intends this. As no physical connectors are used with NFC near field communication, the connection is more reliable and does not suffer problems of contact wear, corrosion and dirt experienced by systems using physical connectors. NFC utilizes inductive-coupling, operating within the globally available unlicensed radio frequency ISM band of 13.56 MHz on ISO/IEC 18000-3 air interface at rates ranging from 106 to 424 kbit/s.

Systems, devices and methods as described hereinafter may use SIM modules for establishing a communication channel with a mobile network operator. A subscriber identity module or subscriber identification module (SIM) is an integrated circuit chip or a circuit on a microchip that is intended to securely store a unique identification code, e.g. an international mobile subscriber identity (IMSI) number and its related key, which are used to identify and authenticate subscribers on mobile devices (such as the MTC devices described hereinafter or mobile phones or computers). It is also possible to store other data, e.g. contacts etc. A SIM module or SIM card may include its unique serial number (ICCID), international mobile subscriber identity (IMSI) number, security authentication and ciphering information, temporary information related to the local network, a list of the services the user has access to, and two passwords: a personal identification number (PIN) for ordinary use, and a personal unblocking code (PUK) for PIN unlocking.

In the following, embodiments are described with reference to the drawings, wherein like reference numerals are generally utilized to refer to like elements throughout. In the following description, for purposes of explanation, numerous specific details are set forth in order to provide a thorough understanding of one or more aspects of embodiments. However, it may be evident to a person skilled in the art that one or more aspects of the embodiments may be practiced with a lesser degree of these specific details. The following description is therefore not to be taken in a limiting sense. The various aspects summarized may be embodied in various forms. The following description shows by way of illustration various combinations and configurations in which the aspects may be practiced. It is understood that the described aspects and/or embodiments are merely examples, and that other aspects and/or embodiments may be utilized and structural and functional modifications may be made without departing from the scope of the present disclosure.

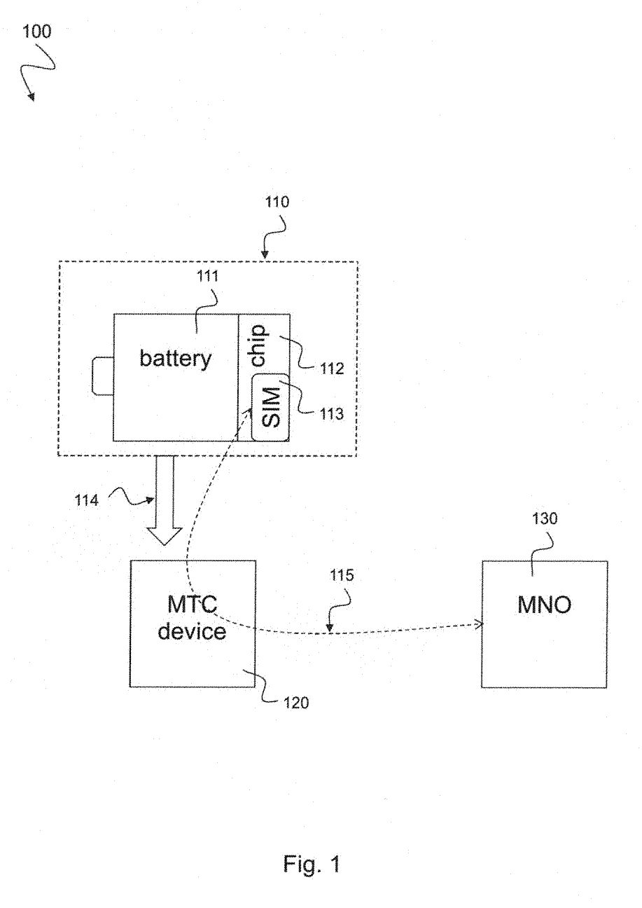

FIG. 1 is a schematic diagram illustrating a communication system 100 with a chip-enhanced battery 110, an MTC device 120 and a MNO network 130 according to an implementation. Multiple such MTC devices 120 can be used in such a communication system 100.

The communication system 100 includes a machine type communication (MTC) device 120 and a mobile network operator (MNO) communication device 130, i.e. a communication device within a network of the MNO. The MTC device 120 is used to initiate a communication channel 115 with the MNO communication device 130 when the chip-enhanced battery 110 is inserted 114 into the MTC device 120.

The chip-enhanced battery 110 can be applied in a machine type communication (MTC) device 120. The chip-enhanced battery 110 includes a battery 111 and a microchip 112 integrated with the battery 111. The microchip 112 includes a subscriber identification module (SIM) 113, e.g. an embedded SIM module that can be used to initiate a communication channel with the mobile network operator (MNO) 130 responsive to an insertion of the chip-enhanced battery 110 into the MTC device 120.

The MTC device 120 may include a unique identification code representing a pre-paid data service charge. The MTC device 120 may be configured to authenticate the chip-enhanced battery with the MNO based on the unique identification code.

The SIM module may be a conventional SIM card with reduced SIM functionality. That is, only basic SIM functions may be implemented, e.g. authentication functions, authorizing functions, billing and/or security functions. The microchip 112 may include a memory to store the unique identification code. The SIM module 113 may read out the unique identification code from the memory and may initiate the communication channel with the MNO based on the unique identification code. In one example, the unique identification code is imprinted on an outside of the chip-enhanced battery.

The microchip 112 may be an integral part of the battery 111, such that disassembling the battery 111 to access the microchip 112 destroys the microchip 112 or at least disables the microchip 112. The battery 111 may be non-rechargable. The battery 111 may include an internal resistance configured to vary its nominal value responsive to an external recharging process. The chip-enhanced battery 110 may include a disabling circuit configured to disable operation of the microchip 112 based on a deviation of the internal resistance from a threshold value.

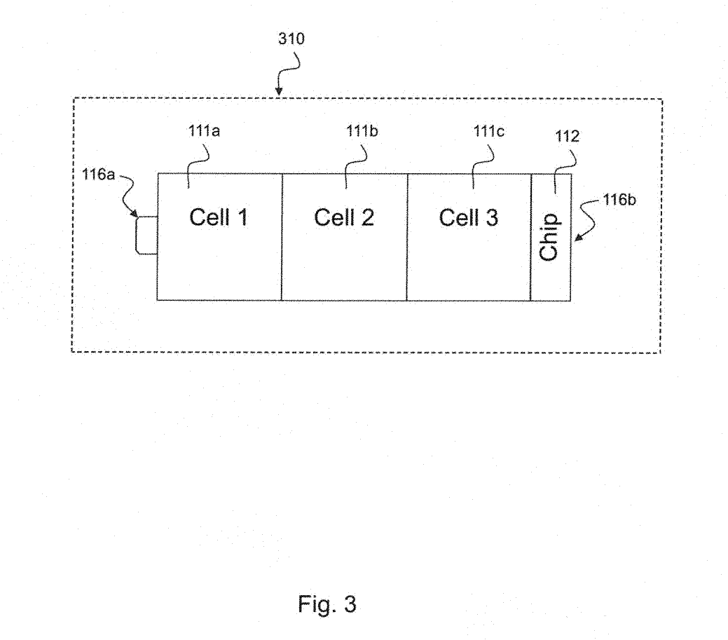

The battery 111 may include one or more electrochemical cells and may be designed as described below with respect to FIG. 3. In one example, the battery 111 may be formed as a coin cell. In one example, the battery may include set of battery cells connected in series. The battery 111 may include a first connector configured to provide the MTC device 120 with a positive supply voltage and a second connector configured to provide the MTC device 120 with a negative supply voltage.

The chip-enhanced battery 110 may include two galvanic power supply contacts configured to supply DC power to the MTC device. In one implementation, the microchip 112 may be configured to communicate with the MTC device 120 based on multiplexing a signal to the DC power. The chip-enhanced battery 110 may include one or more electrical contacts. The microchip 112 may communicate with the MTC device 120 by using the at least one electrical contact.

In one implementation, the chip-enhanced battery 110 may include a light emitting diode (LED). The microchip 112 may communicate with the MTC device 120 by transmitting light between the LED and a light sensitive sensor comprised in the MTC device 120.

In an alternative implementation, the chip-enhanced battery 110 may include a near field communication (NFC) device. The microchip 112 may communicate with the MTC device 120 by radio communication between the NFC device and another NFC device comprised in the MTC device 120.

The battery 111 may include a compartment configured to mount the microchip. The compartment may mount additional circuitry for providing communication between the microchip 112 and the MTC device 120, e.g. NFC drivers or circuitry related to light generation.

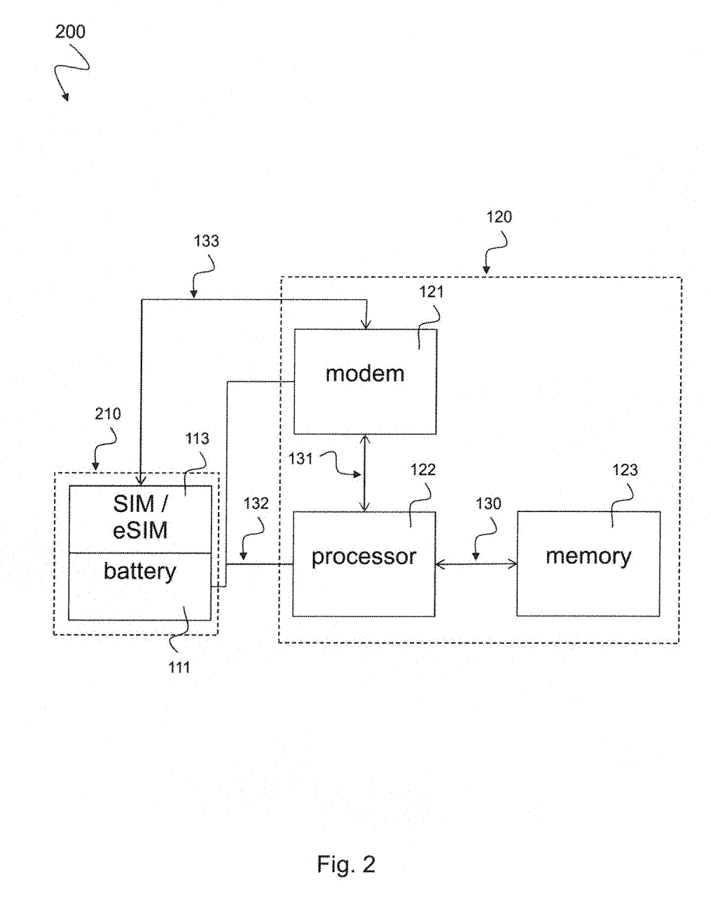

The MTC device 120 may include a modem and a processor, e.g. as described below with respect to FIG. 2, for initiating a communication channel with a mobile network operator (MNO). The MTC device 120 may include the chip-enhanced battery 110 when inserted 114 in the MTC device 120. The SIM module of the chip-enhanced battery 110 may initiate the communication with the MNO upon insertion 114 of the chip-enhanced battery 110 into the MTC device 120.

The MTC device with inserted smart battery 110 may include a unique identification code representing a pre-paid data service charge. The SIM module of the smart battery 110 may authenticate the chip-enhanced battery 110 with the MNO 130 based on the unique identification code. The microchip 112 may include a memory, e.g. a memory 123 as described below with respect to FIG. 2 for storing the unique identification code. The SIM module 113 may read out the unique identification code from the memory and may initiate the communication with the MNO 130 based on the unique identification code.

Of course, the described chip-enhanced battery 110 is not limited to the use in machine type communication devices. For example, such chip-enhanced batteries can also be used in mobile phones, smartphones, tablets etc. for establishing a mobile communication.

FIG. 2 is a schematic diagram illustrating a communications system 200 with a chip-enhanced battery 210 connected with an MTC device 120 according to an implementation. The communication system 200 includes a chip enhanced battery 210, e.g. a chip-enhanced battery 110 as described above with respect to FIG. 1, and a MTC device 120 as described above with respect to FIG. 1.

The chip-enhanced battery 210 is an aggregate device of a battery 111 and a SIM module 113 implemented on a chip which is integrated with the battery 111. The MTC device 120 includes a processor 122, a memory 123 and a modem 121. The processor 122 has a first interface 130 with the memory 123 for storing and reading data to or from the memory 123. The processor 122 has a second interface 131 with the modem 121 for controlling the modem 121. A supply line 132 between battery 132 and MTC device 120 is used for supplying the modem 121 and the processor 122 with electrical power. An interface 133 between the SIM module 113 and the modem 121 is used to provide subscriber ID information and/or authentication information to the modem 121. The modem 121 may initiate a radio communication link with a MNO network controlled by the processor 122. The memory 123 may be used by the processor 122 to store and retrieve data, e.g. subscription information, charging information and information related to the establishment of the communication link with the MNO network.

The MTC device 120, also referred hereinafter as IoT UE, is comprised of main building blocks wireless cellular modem 121, processor 122, memory 123, SIM or eSIM 113 and battery 111, where the chip-enhanced battery 210 including the SIM module 113 and the battery 111 can be inserted in and removed from the MTC device 120. The SIM module 113 can initiate a communication with the MNO. An operator relationship with the MNO and the service of the MNO may be provided pre- or post-paid depending on the contract. Such simple MTC device 120 reduces procuring, provisioning, maintenance and billing costs for the millions and billions of IoT UEs as forecasted.

Complex contract provisioning and management is not necessary. The data service can be provided by an eSIM enhanced battery 210 either with a valid MNO pre-paid or post-paid service subscription as long as the battery 210 can supply energy. The user may have different means of configuring such IoT UEs. For instance, if the user wants a sensor to report a set of measured information very frequently, the data volume will increase, leading towards increased power consumption. As a result, transmissions of high data volumes will require a faster replacement of the smart battery 210. Hence, this way, the system 200 supports a fair low maintenance zero cost business model, since a one-to-one relationship between transfer of data volumes and power consumption is established.

The communication system according to the disclosure presents a new affordable scalable system for IoT UEs connected to wireless cellular networks based on a smart battery combining battery and a chip containing eSIM functions, providing a scalable, flexible and most efficient procurement, provisioning, maintenance and billing. The battery 210 includes an eSIM 113 that may be a microchip or a circuit on a microchip, which contains a unique identification code, representing a pre-paid data service charge. The eSIM 113 has not necessarily to have the full functional set of an eSIM, as discussed and intended as full USIM replacement in terminals. This way, end users can purchase the chip-enhanced battery 210.

Implementing such a chip-on-battery technology will set up a relationship to a MNO as information related to the operator is included in the battery 210. As a consequence, a service provision with the operator can be maintained, until the moment, when battery energy is fully consumed.

The solution paves the way for a successful IoT roll out and business model where the cost for connecting to and transmitting data into the cloud will drop to almost zero and the chipset and IoT UE providers as well as network operators will get paid up front and there is no further ongoing cost.

FIG. 3 is a schematic diagram illustrating an exemplary chip-enhanced battery 310 according to an implementation. In the example the battery is composed by three cells 111a, 111b, 111c, has positive and negative connectors 116a, 116b and a compartment which contains the chip 112 with the value code. The compartment can also contain additional circuitry for the communication with the MTC device as described before. Of course, the chip-enhanced battery 310 may contain any other number of cells, for example one single cell, two cells, four, five, 10, 15, 20 etc. cells.

The chip 112 shall be an integral part of the smart battery 310 and shall not be accessible. The Smart Battery 310 may have unique shapes or sizes, to avoid confusion with conventional batteries. Further different types of IoT devices may require different voltage, thus the combination of cells may vary depending on these requirements. Disassembling the smart battery 310 to access the chip 112 shall destroy the chip 112. The communication between the chip enhanced battery 310 and the MTC device may be done in various ways, which are described as follows:

In a first exemplary implementation, the smart battery 310 has additional galvanic contacts, e.g. 6 for an eSIM, beside the power supply contacts 116a, 116b, being used for a communication between the IoT UE modem/processor and the battery chip 112.

In a second exemplary implementation, the smart battery 310 communicates with the IoT UE modem/processor device by multiplexing a signal to the DC power, which is extracted in the MTC IoT UE modem/processor, e.g. the modem/processor 121, 122 as described above with respect to FIG. 2.

In a third exemplary implementation, the smart battery 310 contains a light emitting diode, and the IoT UE modem/processor 121, 122 has got a light sensitive sensor at the battery holder. Hence the communication can be achievable via a short-range, visible light transmission.

In a forth exemplary implementation, the smart battery 310 contains an NFC device being used for a communication between the IoT UE modem/processor 121, 122 and the battery chip 112.

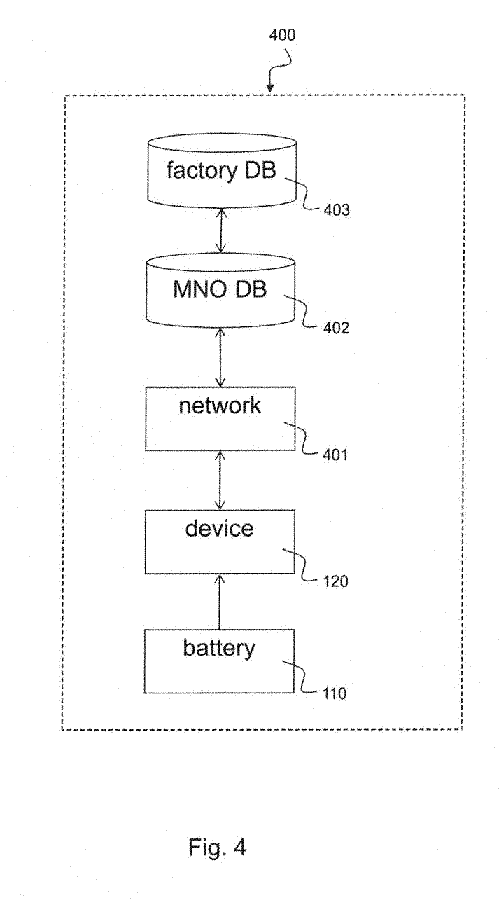

FIG. 4 is a block diagram illustrating a communication system 400 with elements which are involved in the validation process of a chip-enhanced battery according to an implementation, e.g. a chip-enhanced battery 110, 210, 310 as described above with respect to FIGS. 1 to 3.

The battery 110 may be manufactured for specific service providers or mobile network operators. Each battery 110 receives a chip containing a unique code as an eSIM (pre-paid model). The service provider/operator may receive the list of codes for a data base 402. If the battery 110 is inserted to a device 120, the code in the battery 110 may be read out and conveyed via the device 120 and the network 401 to the service provider data base 402. If the code is registered and valid, device 120 is eligible to use the network 401. The code in the data base 402 may for instance be tagged as “in use”, and cannot be reused again.

In an alternative way, the batteries 110 are generic and the battery factory keeps a list of valid codes (post-paid model) in a factory data base (DB) 403. A device 120 may have a pre-configured relationship with a MNO. The value code and a battery factory ID may be retrieved by the device 120, and conveyed via the network 401 to an operator data base 402, this data base 402 may process the battery ID code and contact the factory data base 403 to check if the code is valid. If valid, the factory data base 403 may mark the code as invalid, and operator data base 402 may set the device/battery configuration to valid.

In another alternative implementation, the batteries 110 are generic and the battery factory keeps a list of valid codes in the factory DB 403. The battery 110 may be sold with an imprinted code e.g. a QR code on the outside. The user can register a device 120 with a mobile network operator, by entering the code via a web interface. When the battery 110 is getting inserted, the code may be read out by the device 120. The operator may check if the device 120 has been registered by a user, and may check validity with the battery factory, as described before.

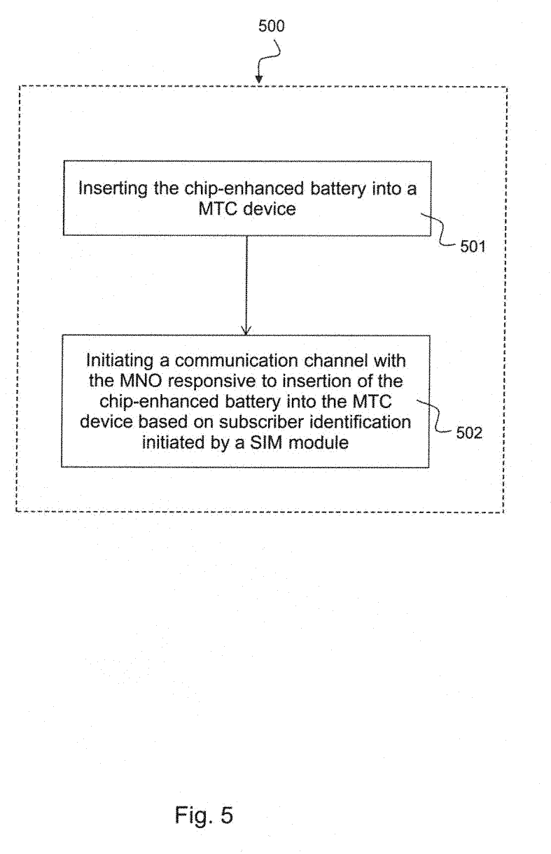

FIG. 5 schematically illustrates an exemplary method 500 for using a chip-enhanced battery for communication with a mobile network operator (MNO) according to an implementation. The chip-enhanced battery, e.g. a chip-enhanced battery 110, 210, 310 as described above with respect to FIGS. 1 to 4, includes a microchip integrated with the battery for communication with the MNO. The microchip includes a subscriber identification module (SIM).

The method 500 includes: inserting 501 the chip-enhanced battery into a machine type communication (MTC) device; and initiating 502 a communication channel with the mobile network operator (MNO) responsive to the insertion of the chip-enhanced battery into the MTC device based on a subscriber identification process initiated by the SIM module of the microchip.

The method 500 may further include: authenticating the chip-enhanced battery with the MNO based on a unique identification code representing a pre-paid data service charge. The method 500 may further include: checking the unique identification code of the chip-enhanced battery with the MNO; and if the unique identification code is checked as valid, enabling the communication of the MTC device with the MNO. The method 500 may further include: checking an amount of data service charge represented by the unique identification code; and enabling the communication of the MTC device with the MNO if the amount of data service charge exceeds a threshold value.

The method 500 may further include: tagging an entry in a data base of the MNO corresponding to the unique identification code as being in use; and locking the entry in the data base of the MNO corresponding to the unique identification code for a reuse. The method 500 may further include: verifying the chip-enhanced battery based on a battery factory identification. The method 500 may further include: looking-up the battery factory identification from a factory data base; and setting the unique identification code as invalid if the battery factory identification is not found in the factory data base.

The method 500 may further include: retrieving the unique identification code from a memory of the microchip. The method 500 may further include: scanning the unique identification code from an imprint on an outside of the chip-enhanced battery, wherein the imprint represents the unique identification code. The method 500 may further include: disabling operation of the microchip based on a deviation of an internal resistance of the battery from a threshold value.

The method 500 may further include: supplying the MTC device with DC power through two galvanic power supply contacts of the chip-enhanced battery; and communicating with the MTC device based on multiplexing a signal to the DC power. The method 500 may further include: communicating with the MTC device by using at least one electrical contact mounted at the chip-enhanced battery. The method 500 may further include: communicating with the MTC device by transmitting light between a light emitting diode (LED) comprised on the chip-enhanced battery and a light sensitive sensor comprised in the MTC device. The method 500 may further include: communicating with the MTC device by radio communication between a near field communication (NFC) device comprised in the chip-enhanced battery and another NFC device comprised in the MTC device.

The microchip as described in this disclosure may be implemented as a Digital Signal Processor (DSP), as a micro-controller or as any other side-processor or hardware circuit on a chip or within an application specific integrated circuit (ASIC).

Embodiments described in this disclosure can be implemented in digital electronic circuitry, or in computer hardware, firmware, software, or in combinations thereof, e.g. in available hardware of mobile devices or in new hardware dedicated for processing the methods described herein.

The present disclosure also supports a computer program product including computer executable code or computer executable instructions that, when executed, causes at least one computer to execute the performing and computing blocks described herein, in particular the method 500 described above with respect to FIG. 5. Such a computer program product may include a readable storage medium storing program code thereon for use by a processor, the program code comprising instructions for performing the method 500 as described above.

### Examples

The following examples pertain to further embodiments. Example 1 is a chip-enhanced battery for a machine type communication (MTC) device, the chip-enhanced battery comprising: a battery; and a microchip integrated with the battery, wherein the microchip comprises a subscriber identification module (SIM) with stored instructions to establish communication with a mobile network operator (MNO) upon an insertion of the chip-enhanced battery into the MTC device.

In Example 2, the subject matter of Example 1 can optionally include a unique identification code associated with a data service plan, wherein the SIM module comprises stored instructions to authenticate the chip-enhanced battery with the MNO based on the unique identification code.

In Example 3, the subject matter of Example 2 can optionally include that the microchip further comprises a storage element configured to store the unique identification code. The storage element can be supported by a cloud service.

In Example 4, the subject matter of Example 3 can optionally include that the SIM module comprises stored instructions to establish the communication with the MNO based on the unique identification code.

In Example 5, the subject matter of any one of Examples 2-4 can optionally include that the unique identification code is disposed on an outer surface of the chip-enhanced battery.

In Example 6, the subject matter of any one of Examples 1-5 can optionally include that the microchip is an integral part of the battery that is destructible if the battery is dissembled to access the microchip.

In Example 7, the subject matter of any one of Examples 1-6 can optionally include that the battery is non-rechargeable.

In Example 8, the subject matter of Example 7 can optionally include that the battery comprises an internal resistance configured to vary its nominal value based on a charging process.

In Example 9, the subject matter of Example 8 can optionally include a disabling logic configured to disable operation of the microchip based on a deviation of the internal resistance from a threshold value. The disabling logic can be implemented in both hardware or software (especially where the phone does not have to be turned on) to perform this disabling function.

In Example 10, the subject matter of any one of Examples 1-9 can optionally include that the battery comprises at least one electrochemical cell. The at least one electrochemical cell may support inductive parasitic coils for wireless charging.

In Example 11, the subject matter of any one of Examples 1-10 can optionally include that the battery is formed as a coin cell.

In Example 12, the subject matter of any one of Examples 1-11 can optionally include that the battery comprises a set of battery cells connected in series.

In Example 13, the subject matter of any one of Examples 1-12 can optionally include that the battery comprises a first connector configured to provide the MTC device with a positive supply voltage and a second connector configured to provide the MTC with a negative supply voltage.

In Example 14, the subject matter of any one of Examples 1-13 can optionally include two galvanic power supply contacts configured to supply DC power to the MTC device, wherein the microchip is configured to communicate with the MTC device based on multiplexing a signal to the DC power.

In Example 15, the subject matter of any one of Examples 1-14 can optionally include at least one electrical contact, wherein the microchip is configured to communicate with the MTC device by using the at least one electrical contact.

In Example 16, the subject matter of any one of Examples 1-15 can optionally include a light emitting diode (LED), wherein the microchip is configured to communicate with the MTC device by transmitting light between the LED and a light sensitive sensor comprised in the MTC device.

In Example 17, the subject matter of any one of Examples 1-16 can optionally include a near field communication (NFC) device, wherein the microchip is configured to communicate with the MTC device by radio communication between the NFC device and another NFC device comprised in the MTC device.

In Example 18, the subject matter of any one of Examples 1-17 can optionally include that the battery comprises a compartment configured to mount the microchip. Alternatively to the compartment a cavity, a bracket etc. can be implemented for mounting the microchip.

In Example 19, the subject matter of Example 18 can optionally include that the compartment is configured to mount additional circuitry for providing communication between the microchip and the MTC device.

Example 20 is a method for using a chip-enhanced battery comprising a battery and a microchip integrated with the battery for communication with a mobile network operator (MNO), wherein the microchip comprises a subscriber identification module (SIM), the method comprising: inserting the chip-enhanced battery into a machine type communication (MTC) device; and initiating a communication channel with the mobile network operator (MNO) responsive to the insertion of the chip-enhanced battery into the MTC device based on a subscriber identification process initiated by the SIM module of the microchip.

In Example 21, the subject matter of Example 20 can optionally include authenticating the chip-enhanced battery with the MNO based on a unique identification code representing a pre-paid data service charge.

In Example 22, the subject matter of Example 21 can optionally include: checking the unique identification code of the chip-enhanced battery with the MNO; and if the unique identification code is checked as valid, enabling the communication of the MTC device with the MNO.

In Example 23, the subject matter of any one of Examples 21-22 can optionally include: checking an amount of data service charge represented by the unique identification code; and enabling the communication of the MTC device with the MNO if the amount of data service charge exceeds a threshold value.

In Example 24, the subject matter of any one of Examples 22-23 can optionally include: tagging an entry in a data base of the MNO corresponding to the unique identification code as being in use; and locking the entry in the data base of the MNO corresponding to the unique identification code for a reuse.

In Example 25, the subject matter of any one of Examples 21-24 can optionally include: verifying the chip-enhanced battery based on a battery factory identification.

In Example 26, the subject matter of Example 25 can optionally include: looking-up the battery factory identification from a factory data base; and setting the unique identification code as invalid if the battery factory identification is not found in the factory data base.

In Example 27, the subject matter of any one of Examples 21-26 can optionally include retrieving the unique identification code from a memory of the microchip.

In Example 28, the subject matter of any one of Examples 21-27 can optionally include scanning the unique identification code from an imprint on an outside of the chip-enhanced battery, wherein the imprint represents the unique identification code.

In Example 29, the subject matter of any one of Examples 20-28 can optionally include: disabling operation of the microchip based on a deviation of an internal resistance of the battery from a threshold value.

In Example 30, the subject matter of any one of Examples 20-29 can optionally include: supplying the MTC device with DC power through two galvanic power supply contacts of the chip-enhanced battery; and communicating with the MTC device based on multiplexing a signal to the DC power.

In Example 31, the subject matter of any one of Examples 20-30 can optionally include communicating with the MTC device by using at least one electrical contact mounted at the chip-enhanced battery.

In Example 32, the subject matter of any one of Examples 20-31 can optionally include communicating with the MTC device by transmitting light between a light emitting diode (LED) comprised on the chip-enhanced battery and a light sensitive sensor comprised in the MTC device.

In Example 33, the subject matter of any one of Examples 1-5 can optionally include communicating with the MTC device by radio communication between a near field communication (NFC) device comprised in the chip-enhanced battery and another NFC device comprised in the MTC device.

Example 34 is a machine type communication (MTC) device, the MTC device comprising: a modem configured to initiate a communication channel with a mobile network operator (MNO); a chip-enhanced battery comprising a battery and a microchip integrated with the battery; and a subscriber identification module (SIM) comprised in the microchip, wherein the SIM module is configured to initiate communication with the MNO via the modem responsive to an insertion of the chip-enhanced battery into the MTC device.

In Example 35, the subject matter of Example 34 can optionally include a unique identification code representing a pre-paid data service charge, wherein the SIM module is configured to authenticate the chip-enhanced battery with the MNO based on the unique identification code.

In Example 36, the subject matter of any one of Examples 34-35 can optionally include that the microchip comprises a memory configured to store the unique identification code.

In Example 37, the subject matter of Example 36 can optionally include that the SIM module is configured to read out the unique identification code from the memory and to initiate the communication with the MNO based on the unique identification code.

In Example 38 is a communication system, comprising: a machine type communication (MTC) device according to one of Examples 34 to 37; and a mobile network operator (MNO) communication device, wherein the MTC device is configured to initiate communication with the MNO communication device responsive to an insertion of the chip-enhanced battery into the MTC device.

In Example 39, the subject matter of Example 38 can optionally include that the MTC device comprises a unique identification code representing a pre-paid data service charge; and that the MTC device is configured to authenticate the chip-enhanced battery with the MNO based on the unique identification code.

Example 40 is a communication device for communication with a mobile network operator (MNO), the communication device comprising: means for inserting a chip-enhanced battery into a machine type communication (MTC) device, wherein the chip-enhanced battery comprises a battery and a microchip integrated with the battery, and wherein the microchip comprises a subscriber identification module (SIM); and means for initiating a communication channel with the mobile network operator (MNO) responsive to the insertion of the chip-enhanced battery into the MTC device based on a subscriber identification process initiated by the SIM module of the microchip.

In Example 41, the subject matter of Example 40 can optionally include means for authenticating the chip-enhanced battery with the MNO based on a unique identification code that represents a pre-paid data service charge.

Example 42 is a computer readable non-transitory medium on which computer instructions are stored which when executed by a computer, cause the computer to perform the method of any one of Examples 20 to 33.

In Example 43, the subject matter of any one of Examples 1 to 17 can further include that the battery comprises means for mounting the microchip.

In Example 44, the subject matter of Example 43 can further include that the means for mounting the microchip comprises at least one of a compartment, a cavity and a bracket.

In addition, while a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Furthermore, it is understood that aspects of the disclosure may be implemented in discrete circuits, partially integrated circuits or fully integrated circuits or programming means. Also, the terms “exemplary”, “for example” and “e.g.” are merely meant as an example, rather than the best or optimal.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

1-25. (canceled)

26. A chip-enhanced battery for a machine type communication (MTC) device, the chip-enhanced battery comprising:
a battery; and
a microchip integrated with the battery,
wherein the microchip comprises a subscriber identification module (SIM) with stored instructions to establish communication with a mobile network operator (MNO) upon an insertion of the chip-enhanced battery into the MTC device.

28. The chip-enhanced battery of claim 26, comprising:
a unique identification code associated with a data service plan,
wherein the SIM module comprises stored instructions to authenticate the chip-enhanced battery with the MNO based on the unique identification code.

28. The chip-enhanced battery of claim 27, further comprising:
a storage element configured to store the unique identification code.

29. The chip-enhanced battery of claim 28,
wherein the SIM module comprises stored instructions to establish the communication with the MNO based on the unique identification code.

30. The chip-enhanced battery of claim 27,
wherein the unique identification code is disposed on an outer surface of the chip-enhanced battery.

31. The chip-enhanced battery of claim 26,
wherein the microchip is an integral part of the battery that is destructible if the battery is dissembled to access the microchip.

32. The chip-enhanced battery of claim 26,
wherein the battery is non-rechargeable.

33. The chip-enhanced battery of claim 32,
wherein the battery comprises an internal resistance configured to vary its nominal value based on a charging process.

34. The chip-enhanced battery of claim 33, comprising:
a disabling logic configured to disable operation of the microchip based on a deviation of the internal resistance from a threshold value.

35. The chip-enhanced battery of claim 26,
wherein the battery comprises at least one electrochemical cell.

36. The chip-enhanced battery of claim 26,
wherein the battery is formed as a coin cell.

37. The chip-enhanced battery of claim 26,
wherein the battery comprises a set of battery cells connected in series.

38. The chip-enhanced battery of claim 26,
wherein the battery comprises a first connector configured to provide the MTC device with a positive supply voltage and a second connector configured to provide the MTC with a negative supply voltage.

39. The chip-enhanced battery of claim 26, comprising:
two galvanic power supply contacts configured to supply DC power to the MTC device,
wherein the microchip is configured to communicate with the MTC device based on multiplexing a signal to the DC power.

40. The chip-enhanced battery of claim 26, comprising:
at least one electrical contact,
wherein the microchip is configured to communicate with the MTC device by using the at least one electrical contact.

41. The chip-enhanced battery of claim 26, comprising:
a light emitting diode (LED),
wherein the microchip is configured to communicate with the MTC device by transmitting light between the LED and a light sensitive sensor comprised in the MTC device.

42. The chip-enhanced battery of claim 26, comprising:
a near field communication (NFC) device,
wherein the microchip is configured to communicate with the MTC device by radio communication between the NFC device and another NFC device comprised in the MTC device.

43. The chip-enhanced battery of claim 26,
wherein the battery comprises a compartment configured to mount the microchip.

44. The chip-enhanced battery of claim 43,
wherein the compartment is configured to mount additional circuitry for providing communication between the microchip and the MTC device.

45. A method for using a chip-enhanced battery comprising a battery and a microchip integrated with the battery for communication with a mobile network operator (MNO), wherein the microchip comprises a subscriber identification module (SIM), the method comprising:
inserting the chip-enhanced battery into a machine type communication (MTC) device; and
initiating a communication channel with the mobile network operator (MNO) responsive to the insertion of the chip-enhanced battery into the MTC device based on a subscriber identification process initiated by the SIM module of the microchip.

46. The method of claim 45, comprising:
authenticating the chip-enhanced battery with the MNO based on a unique identification code representing a pre-paid data service charge.

47. The method of claim 46, comprising:
checking the unique identification code of the chip-enhanced battery with the MNO; and
if the unique identification code is checked as valid, enabling the communication of the MTC device with the MNO.

48. The method of claim 46, comprising:
checking an amount of data service charge represented by the unique identification code; and
enabling the communication of the MTC device with the MNO if the amount of data service charge exceeds a threshold value.

49. A machine type communication (MTC) device, the MTC device comprising:
a modem configured to initiate a communication channel with a mobile network operator (MNO);
a chip-enhanced battery comprising a battery and a microchip integrated with the battery; and
a subscriber identification module (SIM) comprised in the microchip, wherein the SIM module is configured to initiate communication with the MNO via the modem responsive to an insertion of the chip-enhanced battery into the MTC device.

50. The MTC device of claim 49, comprising:
a unique identification code representing a pre-paid data service charge,
wherein the SIM module is configured to authenticate the chip-enhanced battery with the MNO based on the unique identification code.
